(19) United States
(12) Patent Application Publication
(10) Pub. No.: US 2023/0212047 A1
(43) Pub. Date: Jul. 6, 2023

(54) Articulating Diffuser Device, System, and Method

(71) Applicant: Wholesale Septic Supplies, LLC, Dayton, TX (US)

(72) Inventor: Adam Caleb Speer, Dayton, TX (US)

(73) Assignee: Wholesale Septic Supplies, LLC, Dayton, TX (US)

(21) Appl. No.: 17/681,442

(22) Filed: Feb. 25, 2022

Related U.S. Application Data
(63) Continuation-in-part of application No. 29/822,129, filed on Jan. 6, 2022.

(51) Int. Cl. C02F 3/20

(52) U.S. Cl. CPC C02F 3/201; C02F 2103/005; C02F 2301/066

(57) ABSTRACT

A diffuser is disclosed and claimed that can be used in multiple applications, which will sink and operate in the location where it is desired and has the ability to be maneuvered around obstacles. According to one aspect of the invention, a device for aeration of septic tanks is provided. In at least one example, the device comprises: a system of articulating gas-transporting joints; a plurality of porous sections; a bifurcating joint connecting said system of articulating joints to said porous sections; a plurality of weights; and a plate connected to said weights, said bifurcating joint, and said porous sections.

### RELATED APPLICATIONS

This application is a continuation in part of U.S. Design Pat. Application No. 29/822,129, filed on Jan. 06, 2022 titled “Articulating Diffuser”.

### BACKGROUND OF THE INVENTION

Generally, the invention relates to the field of septic tank aeration. Aerobic bacteria is needed to dispose of harmful bacterial and other pathogens in waste water and suspended solids. The aerobic bacteria require a large amount of oxygen. Improving aeration improves water purity, health, and safety.

Previously, people have performed this function with, ridged, fixed location diffusers, connected to hoses that are susceptible to kinking and other causes of obstructed air-flow. There has been at least one attempt to have a diffuser without a fixed location. However, that device has the following problems: poor maneuverability and difficulty in directing the diffuser to an efficient location in the tank.

### SUMMARY OF EXAMPLE EMBODIMENTS

Accordingly, there is a need for a diffuser that can be used in multiple applications, what will sink and operate in the location where it is desired and has the ability to be maneuvered around obstacles.

According to one aspect of the invention, a device for aeration of septic tanks is provided. In at least one example, the device comprises: a system of articulating gas-transporting joints; a plurality of porous sections; a bifurcating joint connecting the system of articulating joints to the porous sections; a plurality of weights; and a plate connected to the weights, the bifurcating joint, and the porous sections. In one example, the system of articulating joints comprises a plurality of rotating joints capable of rotating three hundred and sixty degrees on a plane of rotation, and each the plane of rotation being parallel to each other plane of rotation. In one such example, the plurality of rotating joints comprises two rotating joints separated by a straight tube such that an axis of rotation of each joint is approximately six and one quarter inches apart from each other, the rotating joints each comprises a resistance to rotation of approximately 13 inch-pounds, the system of articulating joints is constructed of a plastic material (for example, polyvinyl chloride (a.k.a. “PVC”) and comprises a plurality of male threaded connections, and the system of articulating joints comprises a continuous length of tube.

In a further example, the male threaded connections are positioned at each end of the continuous length of tube, wherein the male threaded connections and the continuous length of tube are about one half inch in diameter.

In another example, the porous sections are approximately nine and seven eighths’ inches long, the porous sections comprise a male threaded connection and a plugged end, the male threaded connection is one half inch in diameter, and the porous sections comprises an outside diameter of approximately one inch. In still another example, the septic tank comprises a depth of fluid sufficient to submerge the porous sections, and the depth of fluid comprises a water and air interface, wherein the porous sections are positioned and arranged to generate a certain of bubbles with dimensions of approximately one inch wide, nine and seven eighths’ inches long, and reaching from the porous sections to the water and air interface, wherein the plurality of porous sections consists of essentially of two porous sections the system of articulating joints comprises a connection to an incoming supply of air (e.g., one of the male threaded connections). Further, in some examples, the porous sections have a porosity sufficient to manipulate the incoming supply of air into a plurality of small bubbles, the incoming air comprises a septic air compressor, septic aerator, and/or septic air pump, the porous sections have a porosity sufficient to create bubbles that are large enough to allow the septic air compressor to function properly and the porous sections comprises a plastic material, the wherein the weights comprise: a hollow tube, a plurality of caps, and a dense filler material filling the hollow tube. In some such examples, the caps are placed at the ends of the hollow tube to contain the dense filler material within the hollow tube, the dense filler material comprises sand, and the caps and the hollow tube are constructed out of a plastic material (for example, PVC).

In some examples, the septic tank comprises an anticipated depth of sediment, and the weights have a dimension substantially perpendicular to the plate that is greater than the anticipated depth of the sediment, the bifurcating joint splits the incoming supply of air into a plurality of symmetrical streams of air by directing the incoming supply of air through a plurality of elbows that provide a change to the direction of the symmetrical streams of air, the bifurcating joint comprises a plurality of female threaded connections connecting the female threaded connections connect the system of articulating joints and the porous sections to the bifurcating joint, wherein the plate comprises a plastic material and a plurality of holes sufficient to reduce a torque on the system of articulating joints, wherein the torque provided by water in the septic tank pressing on the plate during instillation, wherein the plate comprises a plurality of holes perpendicular to a surface of the plate whereas the surface faces water/air interface, and the surface of the plate measures approximately eight- and one-half inches in width by approximately fourteen inches in length, wherein the surface of the plate comprising a surface area of approximately one hundred and nineteen square inches when the holes are ignored. In some examples, the holes reduce the surface area of the surface of the plate facing the water/air interface by approximately 25.5 square inches.

In at least one example, the plate is constructed of a material with a density slightly less than that of the water, a combined height of the plate and the weights are tall enough to prevent the bubbles from the porous sections from significantly disturbing sediment in the septic tank, the plate has dimensions of approximately nine inches, by fourteen inches by one and one quarter inches.

In a further example, the porous sections comprise a cylindrical geometry including a central axis and a cross section that is substantially circular in geometry, and includes a center, wherein the central axis passes through the center of the cross section of the cylindrical geometry, the central axis is oriented in the same direction as the plate length, and the porous sections are oriented such that each the central axis is parallel to each other the central axis, wherein the fittings comprise: a plurality of metallic bolts, a plurality of metallic nuts, a plurality of metallic washers, a plurality of metallic screws, a plurality of metallic clamps, wherein the metallic bolts, the metallic washers, and the metallic nuts bind the weights to the plate, wherein the metallic screws and the metallic clamps bind the bifurcating joint and the porous sections to the plate, wherein the weights are positioned on the same face of the plate but at opposite ends of the plate, wherein the weights comprise a cylindrical geometry which comprises a plurality of circular cross sections which comprise a center. In at least one such example, each of the weights comprises a central axis such that the central axis passes through the center of the plurality of cross sections wherein the central axis of the weights are positioned such that each central axis is parallel to the central axis of the other weights.

According to a further aspect of the invention, a process is provided for installing an articulating diffuser in a septic tank having water therein, the process comprising: connecting of a tube to a system of articulating joints, manipulation of the system of articulating joints such that the articulating diffuser is configured into an instillation angle, maneuvering the articulating diffuser, inserting the articulating diffuser into the septic tank, maneuvering the articulating diffuser around at least one obstacle, manipulating the system of articulating joints such that the articulating diffuser is configured into an operation angle, maneuvering the articulating diffuser to a final location, and resting the articulating diffuser at the final location.

In at least one such process, the manipulation comprises a rotation of the system of articulating joints, the connecting comprises a rigid bonding of the system of articulating joints to the pipe or tube, the inserting comprises the articulating diffuser entering an opening within the septic tank, the maneuvering comprises changing the position of the articulating diffuser, the manipulating comprises applying a force to the tube to create a torque within the system of articulating joints or applying a force directly to the system of articulating joints. In some alternative examples, the manipulating comprises applying a force directly to the system of articulating joints, or the manipulating comprises applying a force to the articulating diffuser.

In at least one further example, the maneuvering and the inserting comprises moving the articulating diffuser. In some examples, the maneuvering and the inserting comprises moving the tube, wherein the resting comprises lowering the articulating diffuser onto a bottom of the septic tank, and wherein the resting comprises leaving the articulating diffuser to sit at the operation location.

In yet another aspect of the invention, a system is provided for installing a diffuser assembly in a septic tank having water therein, the system comprising: means for creating a connection between a system of articulating joints and a pipe or tube; means for manipulating the system of articulating joints; means for raising the articulating diffuser; means for inserting the articulating diffuser into the septic tank; and means for maneuvering the articulating diffuser; wherein:
the means for creating a connection comprises a male threaded connection on the system of articulating joints and a female threaded connection provided by an air supply pipe or tube;
the means for manipulating the system of articulating joints comprises a pipe supplying compressed air and the plate of the diffuser;
the means for raising the diffuser assembly comprises the pipe or tube connected to the system of articulating joints;
the means for inserting the articulating diffuser comprises the pipe supplying compressed air; and
the means for maneuvering the articulating diffuser comprises the pipe supplying compressed air.

In still a further example, a process is provided for oxygenating water in a septic tank therein, the process comprising:
compressing an amount of ambient air;
conveying compressed the amount of ambient air as a stream of compressed air;
bifurcating the stream of compressed air to create a plurality of symmetrical air streams;
manipulating the symmetrical streams of air into a multitude of small bubbles; and
dissolving an amount of oxygen available in the multitude of small bubbles into the amount of water.

In at least one example, the compressing of an amount of ambient air comprises compressing air at an ambient pressure to a pressure sufficient to facilitate creation of the stream of compressed air, the conveying comprises confining the stream of compressed air such that the stream is created within a compression chamber and can only flow to a diffuser assembly, and dissolving is facilitated by the small bubbles comprising a higher oxygen concentration than the water.

In yet another aspect of the invention, a system for oxygenating a septic tank and an amount of water therein, the system comprising: means for compressing an amount of ambient air; means for conveying a stream of compressed air; means for bifurcating the stream of compressed air into a plurality of symmetrical air streams; means for manipulating the symmetrical air streams into a multitude of small bubbles; and means for dissolving an amount of oxygen available in the multitude of small bubbles into the water; wherein:
the means for compressing an amount of ambient air comprises a septic aerator,
the means for compressing an amount of ambient air comprises a septic air compressor,
the means for compressing an amount of ambient air comprises a septic air pump,
the means for compressing has the capability to compress the amount of ambient air to a point where it possesses a pressure greater than a pressure presented by a hydrostatic pressure of the water at a prescribed depth,
the means for conveying a stream of compressed air comprises a continuous length of pipe and/or tube connecting the means to compress an amount of air to the means to bifurcate the stream of compressed air, and the means to bifurcate the stream of compressed air connects the means to convey a stream of compressed air to the means to manipulate the symmetrical air streams into a multitude of small bubbles, and
the means to dissolve an amount of oxygen comprises the multitude of small bubbles having a concentration of oxygen that is greater than the water and causes the amount of oxygen to naturally diffuse into the water.

### BRIEF DESCRIPTION OF THE DRAWINGS

For a thorough understanding of the present invention, reference is made to the following detailed description of the preferred embodiments, taken in conjunction with the accompanying drawings in which reference numbers designate like or similar elements throughout the several figures of the drawing. Briefly:

FIG. 1 shows a perspective view of an example of the invention.

FIG. 2 shows an exploded view of an example of the invention.

FIG. 3 shows a sectional view of an example of the invention.

FIG. 4 shows a sectional view of an example of the invention.

FIG. 5 shows a perspective view of an example of the invention.

FIG. 6 shows a sectional view of an example of the invention.

### DETAILED DESCRIPTION OF EXAMPLES OF THE INVENTION

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems and method steps. It is to be expected that various equivalents, alternatives, and modifications are possible within the scope of the appended claims.

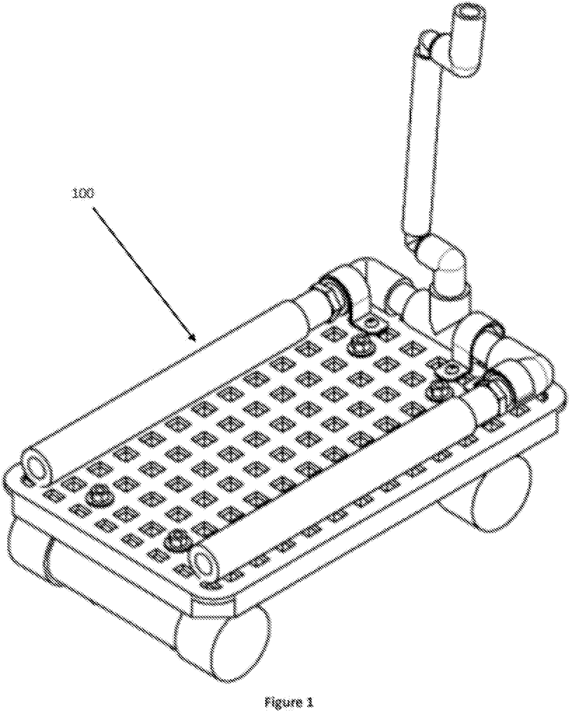

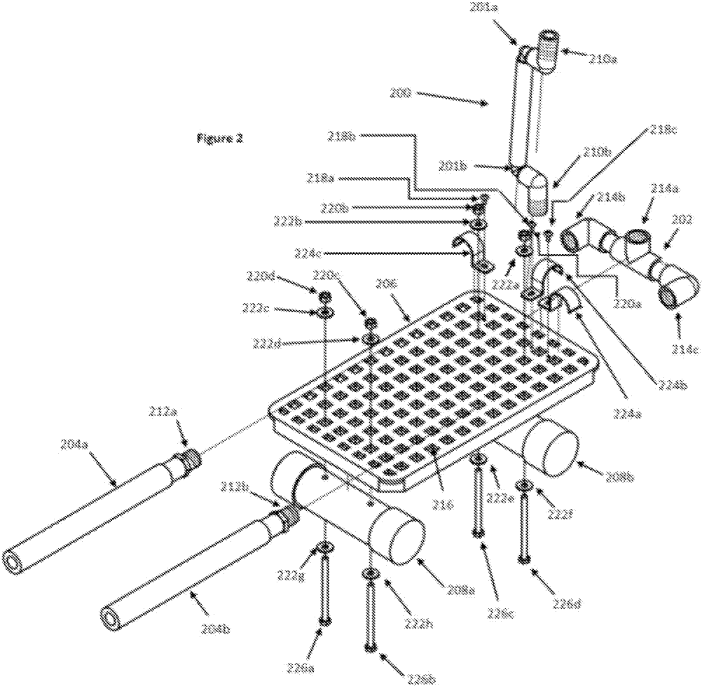

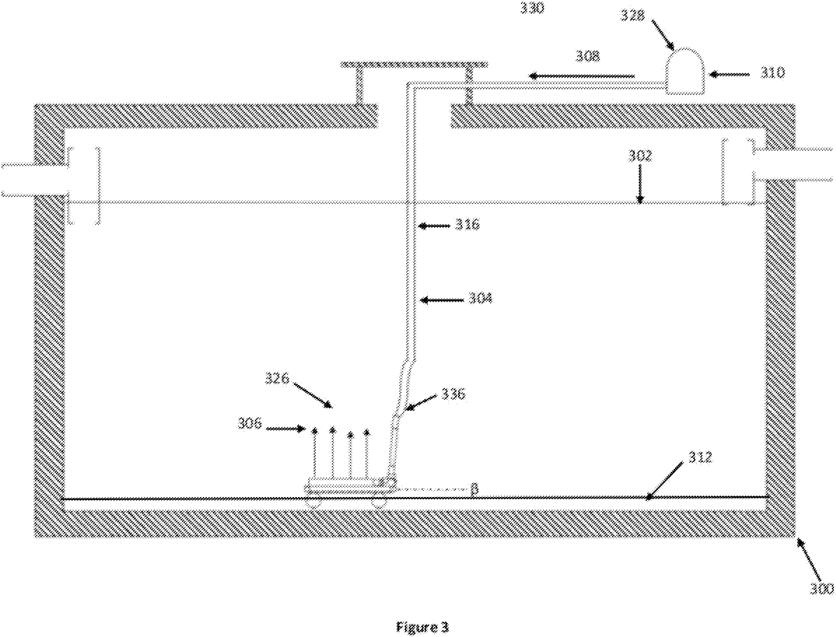

As seen in FIG. 1, according to an aspect of the invention, a device (100) is provided for aeration of a septic tank (300), seen in FIG. 3. In the illustrated example, as seen in FIG. 1 and in an expanded view in FIG. 2, the device (100) includes a system of articulating joints (200) wherein a plurality (in this example, there are two) of rotating joints (201a-202b) allows device (100) to be configured into a plurality of orientations. Further, a bifurcating joint (202) is connected to the system of articulating joints (200) to split compressed air (308), seen in FIG. 3, into multiple streams. A plurality (here, two) of porous sections (204a-204b) is connected to the bifurcating joint (202) that allow bubbles (306) (see FIG. 3) to escape into septic tank (300). Referring again to FIG. 2, a plate (206) is connected to the porous sections (204a & 204b), the bifurcating joint (202), and a plurality of weights (208a & 208b). The plate (206) connect all of the components.

In at least one example, screws (218a-218c) and clamps (224a-224c) connect the bifurcating joint (202) and porous sections (204a & 204b) to plate (206). Additionally, nuts (220a-220d), bolts (226a-226d) and washers (222a-222h) connect weights (208a-208b) to plate (206).

In at least one example, (e.g. FIG. 3), the septic tank (300) contains water (302) sufficiently deep to submerge porous sections (204a & 204b). Referring again to FIG. 2, in at least one such example, at least one of the rotating joints (201a & 201b) is capable of rotating three hundred and sixty degrees. In a further example, the system of articulating joints (200) is constructed of a plastic material (for example polypropylene) with a plurality of male threaded connections (210a & 210b). In a further example, joints (201a & 201b) and male threaded connections (210a & 210b) are about one-half inch in diameter. In a further example, plurality of rotating joints (201a & 201b) are separated from each other by about six and one quarter inches. In a further example, rotating joints (201a & 201b) each possesses a resistance to rotation of approximately 13 inch-pounds. Referring again to FIG. 3, in a further example, threaded male connection (210a) connects device (100) to an air supply pipe (304).

In a further example, as seen in FIG. 2, porous sections (204a & 204b) are approximately nine and seven eighths’ inches long, and porous sections (204a & 204b) comprise male threaded connections (212a & 212b), which are plugged at an end that is opposite of threaded connections (212a & 212b). In a further example, male threaded connections (212a & 212b) are about one-half inch in diameter. In a further example, porous sections (204a & 204b) comprises an outside diameter of approximately one inch and porous sections (204a & 204b) allow a multitude of small bubbles (306) to leave device (100), having a porosity sufficient to manipulate compressed air (308) into multitude of small bubbles (306). Referring again to FIG. 3, compressed air (308) is provided by an air compressor (310) functioning according to the following performance specification: between about 2.4 and about 4.5 cubic feet of air per minute at about 2.13 pounds per square inch. Referring again to FIG. 2, in a further example, porous sections (204a & 204b) are constructed of a plastic material (e.g., polypropylene).

In yet another example, plurality of weights (208a & 208b) include material (e.g. sand) that is denser than water.

In a further example, as seen in FIG. 3, in septic tank (300), there is an anticipated depth of sediment (312), and weights (208a-208b) have a dimension substantially perpendicular to plate (206) that is greater than the anticipated depth of sediment (312) to keep plate (206) above the sediment (312). Maintaining plate (206) above the sediment prevents bubbles (306) from disturbing sediment (312) and prevents sediment (312) from leaving septic tank (300). In at least one such example, weights (208a & 208b) are positioned on the same face of plate (206) but at opposite ends of plate (206).

Referring again to FIG. 2, in still another example, bifurcating joint (202) splits compressed air (308) into a stream for each of porous sections (204a & 204b), bifurcating joint (202) comprises a plurality of female threaded connections (214a-214c), and female threaded connections (214a-214c) connect the system of articulating joints (200) and porous sections (204a & 204b) to bifurcating joint (202).

In a further example, plate (206) comprises a plastic material (e.g. polypropylene) and a plurality of holes (216) that reduce a torque on the system of articulating joints (200). Torque is provided by water (302) flowing around plate (206) during instillation. In a further example, a combined height of plate (206) and weights (208a-208b) is sufficient to prevent small bubbles (306) from significantly disturbing the sediment (312). In a further example, plate (206) has dimensions such that plate (206) possesses a width of approximately nine inches, a length of approximately fourteen inches, and a height of approximately one and one quarter inches.

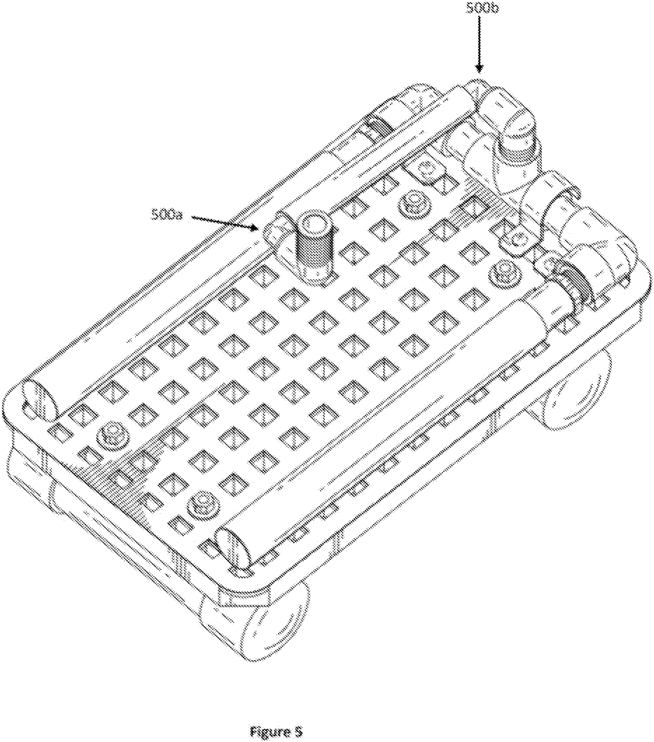

FIG. 5 depicts two rotating joints (500a & 500b). Rotating joints (500a & 500b) allow alternate states of joints (201a & 201b), which, in the illustrated example joints (201a & 201b) are capable or rotating 360 degrees. Rotated joints (500a & 500b) show one possible configuration of joints (201a and 201b).

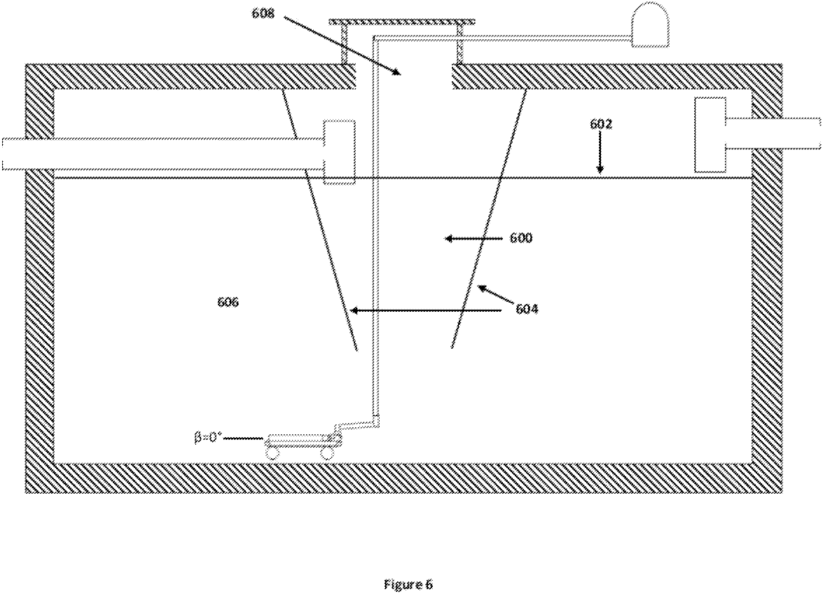

FIG. 6 depicts device (100) within a septic tank with a clarifier (600). Some aerobic septic tanks only have access to their aerobic chamber (606) through an access port (608) in clarifier (600). Rotating joints (201a & 201b), seen in FIG. 2, allow device (100) to be maneuvered around the clarifier walls (604). Thus, device (100) can aerate aerobic camber (606) and leave clarifier (600) undisturbed. Clarifier (600) should remain undisturbed to ensure contaminants settle out of the water (602).

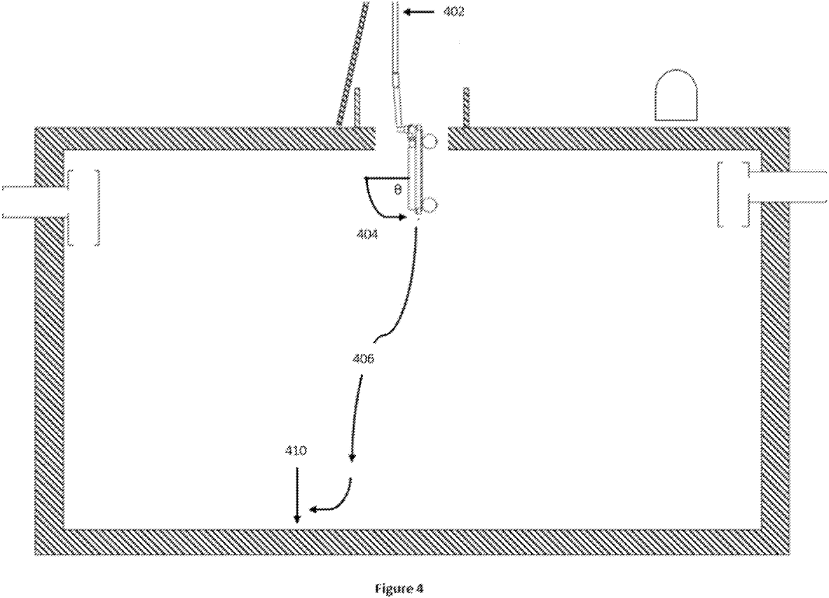

As seen in FIGS. 3 and 4, according to a further aspect of the invention, a process is provided for installing an articulating diffuser device (100) in a septic tank (300) having water (302) therein, the process comprising: connecting a pipe (402) to a system of articulating joints (200); manipulating system of articulating joints (200) to configure device (100) into an instillation angle θ and operation angle β.

In a further example, the connecting comprises threading a pipe (402) to male threaded connection (210a) the manipulating (404) comprises a rotation of the system of articulating joints (200), instillation angle θ is approximately 90 degrees, and operation angle β is approximately zero degrees. The mentioned angles measure how much the uppermost surface of the plate deviates from being horizontal.

As seen in FIG. 3 and FIG. 4, according to a further aspect of the invention, a system is provided for installing an aerobic diffuser device (100) in a septic tank (300) having water (302) therein, the system comprising: means for connecting device (100) and pipe (304); and means for manipulating device (100) into an installation angle θ and operation angle β.

In a further example, wherein the means for connecting comprises a male threaded connection (210a) on device (100) and a female threaded connection (336) on pipe (304).

In a further example, means for manipulating (316) device (100) comprises pipe (304) and plate (206). An individual installing device (100) pushes on plate (206) and pipe (304) to rotate joints (201a & 201b) in to the position angle θ and is then lowered through path 406 where it contacts bottom 410, further application of pressure through the connections to articulating joints (201a and 201b) cause device (100) to rest on the bottom 410 of the septic tank and the individual installing the device pushes on pipe (304), causing the system of articulating joints (200) to rotate to operation angle β.

As seen in FIG. 3, according to yet another aspect of the invention, a process for oxygenating a septic tank (300) and water (302) is provided. In at least one example, the process comprises: compressing air; bifurcating a stream of compressed air (308); manipulating compressed air (308) into a multitude of small bubbles (306); and dissolving oxygen available in the multitude of small bubbles (306) into water (302).

In a further example, the compressing increases the pressure of the air until it is sufficient to overcome the hydrostatic pressure of water (302).

In a further example, dissolving occurs at the interface of water (302) small bubbles (306).

As seen in FIG. 3, according to a further aspect of the invention, a system is provided for oxygenating a septic tank and water (302) therein, the system comprising: means for compressing ambient air into compressed air (308); means to bifurcate compressed air (308); means for manipulating compressed air (308) into a multitude of small bubbles (306); and means for dissolving oxygen into water (302). In at least one such example, the means for compressing (328) ambient air (330) comprises air compressor (310). In some examples, air compressor (310) comprises a septic aerator, linear diaphragm aerator, piston aerator, or another type of air compressor capable of moving between 2.4 and 4.5 cubic feet of air per minute at 2.13 pounds per square inch.

In a further example, the means for manipulating compressed air (308) into a multitude of small bubbles (306) comprises porous section (204a & 204b).

In a further example, the means for dissolving oxygen comprises the multitude of small bubbles (306) that possess a higher concentration of oxygen than water (302). The difference between the concentrations of oxygen in the multitude of small bubbles (306) and water (302) causes oxygen to naturally diffuse from bubbles (306) to water (302).

As seen in FIG. 3, according to a further aspect of the invention, a process is provided to accelerate the diffusion of oxygen into a septic tank (300) and water (302) therein, the process comprising: compressing ambient air (330) into compressed air (308); bifurcating compressed air (308); manipulating compressed air (308) into a multitude of small bubbles (306); dissolving oxygen (326) into water (302). In at least one such example, compressing of ambient air (330) increases air pressure until it is greater than the hydrostatic pressure of water (302); the dissolving oxygen (326) comprises providing multitude of small bubbles (306) that possess a higher concentration of oxygen than water (302). The difference between the concentrations of oxygen in multitude of small bubbles (306) and water (302) causes oxygen to naturally diffuse from bubbles (306) to water (302). In a further example, the multitude of small bubbles (306) accelerate the rate at which oxygen dissolves into water (302), because the multitude of small bubbles (306) (e.g., between about 200 and 350 microns in diameter) provide a larger surface between air and water (302) than would occur naturally. The increase in surface area increases the rate at which oxygen diffuses into water (302).

As seen in FIG. 3, according to a further aspect of the invention, a process is provided for circulating water (302) in a septic tank (300), the process comprising: compressing ambient air (330) into compressed air (308); and releasing compressed air (308) below the surface of water (302). In at least one such example, the compressing of ambient air (330) increases its pressure so that it is of a higher pressure than the hydrostatic pressure of water (302); releasing of compressed air (308) causes an imbalance of pressure within water (302), and water (302) will move to reach a stable state.

As seen in FIG. 3, according to a further aspect of the invention, a system is provided for circulating water (302) in a septic tank (300), the system comprising: means for compressing ambient air (330) into compressed air (308); and means for releasing compressed air (308) in water (302). In at least one such example, the means for compressing ambient air (300) comprises air compressor (310). In a further example, the means for releasing compressed air (308) comprises porous section (204a & 204b).

As seen in FIG. 3, according to a further aspect of the invention, a process is provided for promoting the proliferation of aerobic bacteria and limiting the proliferation of anaerobic bacteria in a septic tank (300) and water (302) therein. In at least one example, the process comprises: compressing ambient air (330) into compressed air (308) and manipulating the compressed air into a multitude of small bubbles (306). In one such example, the compressing of ambient air (330) increases its pressure so that it is of a higher pressure than the hydrostatic pressure of water (302). In a further example, the multitude of small bubbles (306) naturally dissolve oxygen into water (302). Furthermore, the dissolved oxygen is sufficient to support aerobic bacteria and disrupt the cellular function of anaerobic bacteria.

As seen in FIG. 3, according to a further aspect of the invention, a system is provided for promoting the proliferation of aerobic bacteria and limiting the proliferation of anaerobic bacteria in a septic tank (300) and water (302) therein, the system comprising: means for compressing ambient air (330) into compressed air (308); means for manipulating compressed air (308) into a multitude of small bubbles (306); and means for dissolving oxygen (326) into water (302). In at least one example, the means for compressing (328) ambient air (330) comprises an air compressor (310). In a further example, the means for manipulating compressed air (308) into small bubbles (306) comprises plurality of porous sections (204a & 204b). In a further example, the means for dissolving oxygen (326) comprises the multitude of small bubbles (306) that possess a higher concentration of oxygen than water (302). The difference between the concentrations of oxygen in the multitude of small bubbles (306) and water (302) causes oxygen to naturally diffuse from bubbles (306) to water (302). The dissolved oxygen will then disrupt cellular functions of anaerobic bacteria and promote the proliferation of aerobic bacteria.

Although the invention has been described with reference to a particular embodiment, this description is not meant to be construed in a limiting sense. Various modifications of the disclosed embodiments as well as alternative embodiments of the invention will become apparent to persons skilled in the art.... It is therefore contemplated that the appended claims will cover any such modifications or embodiments that fall within the scope of the invention.

What is claimed is:

1. A device for aeration of septic tanks, the device comprising:
a system of articulating gas-transporting joints;
a plurality of porous sections;
a bifurcating joint connecting said system of articulating joints to said porous sections;
a plurality of weights;
a plate connected to said weights, said bifurcating joint, and said porous sections.

2. A device as in claim 1 wherein said system of articulating joints comprises a plurality of rotating joints capable of rotating three hundred and sixty degrees on a plane of rotation, and each said plane of rotation being parallel to each other plane of rotation.

3. A device as in claim 2 wherein said plurality of rotating joints comprises two rotating joints separated by a straight tube such that an axis of rotation of each joint is approximately six and one quarter inches apart from each other.

4. A device as in claim 2 wherein said rotating joints each comprises a resistance to rotation of approximately 13 inch-pounds.

5. A device as in claim 1 wherein said system of articulating joints comprises a connection to an incoming supply of air.

6. A device as in claim 5 wherein said connection to an incoming supply of air comprises at least one of male threaded connection.

7. A device in claim 5 wherein said porous sections have a porosity sufficient to manipulate said incoming supply of air into a plurality of small bubbles, said incoming air comprises a septic air compressor, septic aerator, and/or septic air pump, said porous sections have a porosity sufficient to create bubbles that are large enough to allow said septic air compressor to function properly and said porous sections comprises a plastic material.

8. A device as in claim 1 wherein said weights comprise;
a hollow tube;
a plurality of caps; and
a dense filler material filling said hollow tube.

9. A device as in claim 8 wherein said caps are placed at the ends of said hollow tube to contain said dense filler material within said hollow tube, said dense filler material comprises sand, and said caps and said hollow tube are constructed out of a plastic material.

10. A device as in claim 1 wherein,
said septic tank comprises an anticipated depth of sediment,
said weights have a dimension substantially perpendicular to said plate that is greater than the anticipated depth of said sediment, said bifurcating joint splits said incoming supply of air into a plurality of symmetrical streams of air by directing said incoming supply of air through a plurality of elbows that provide a change to the direction of said symmetrical streams of air,
said bifurcating joint comprises a plurality of female threaded connections connecting said system of articulating joints and said porous sections to said bifurcating joint.

11. A device as in claim 1 wherein said plate comprises a plastic material including a plurality of holes sufficient to reduce a torque on the said system of articulating joints, wherein said torque is provided by water in the septic tank pressing on said plate during instillation, wherein said plate comprises a plurality of holes perpendicular to a surface of said plate whereas said surface faces water/air interface, and said surface of said plate measures approximately eight- and one-half inches in width by approximately fourteen inches in length, wherein said surface of said plate comprising a surface area of approximately one hundred and nineteen square inches when said holes are ignored.

12. A device as in claim 11 wherein said holes reduce the surface area of said surface of said plate facing said water/air interface by approximately 25.5 square inches.

13. A process for installing an articulating diffuser in a septic tank having water therein, the process comprising:
connecting of a tube to a system of articulating joints;
manipulation of said system of articulating joints such that the articulating diffuser is configured into an instillation angle;
maneuvering the articulating diffuser;
inserting the articulating diffuser into said septic tank;
maneuvering the articulating diffuser around at least one obstacle;
manipulating the system of articulating joints such that said articulating diffuser is configured into an operation angle;
maneuvering said articulating diffuser to a final location; and
resting said articulating diffuser at said final location.

14. A system for installing a diffuser assembly in a septic tank having water therein, the system comprising:
means for creating a connection between a system of articulating joints and a pipe or tube;
means for manipulating said system of articulating joints;
means for raising said articulating diffuser;
means for inserting said articulating diffuser into said septic tank; and
means for maneuvering said articulating diffuser.

15. A process for oxygenating water in a septic tank therein, the process comprising: compressing an amount of ambient air;
conveying compressed said amount of ambient air as a stream of compressed air;
bifurcating said stream of compressed air to create a plurality of symmetrical air streams;
manipulating said symmetrical streams of air into a multitude of small bubbles; and
dissolving an amount of oxygen available in said multitude of small bubbles into said amount of water.

16. A system for oxygenating a septic tank and an amount of water therein, the system comprising:
means for compressing an amount of ambient air;
means for conveying a stream of compressed air;
means for bifurcating said stream of compressed air into a plurality of symmetrical air streams;
means for manipulating said symmetrical air streams into a multitude of small bubbles; and
means for dissolving an amount of oxygen available in said multitude of small bubbles into said water.

17. A system as in claim 16 wherein said means to dissolve an amount of oxygen comprises said multitude of small bubbles having a concentration of oxygen that is greater than said water and causes said amount of oxygen to naturally diffuse into said water.
